(19) United States
(12) Patent Application Publication
(10) Pub. No.: US 2026/0004567 A1
(43) Pub. Date: Jan. 1, 2026

(54) IMAGE PROCESSING SYSTEM, IMAGE PROCESSING METHOD, AND INFORMATION STORAGE MEDIUM

(71) Applicant: Rakuten Asia Pte. Ltd., Singapore (SG)

(72) Inventors: Sehyung LEE, Tokyo (JP); Yeongnam CHAE, Tokyo (JP)

(73) Assignee: Rakuten Asia Pte. Ltd., Singapore (SG)

(21) Appl. No.: 19/250,177

(22) Filed: Jun. 26, 2025

(30) Foreign Application Priority Data
Jun. 27, 2024 (JP) 2024-104042

(51) Int. Cl. G06V 10/774; G06V 10/75; G06V 10/776; G06V 10/82; G06V 10/94; G06V 30/414

(52) U.S. Cl. CPC G06V 10/7747; G06V 10/75; G06V 10/776; G06V 10/82; G06V 30/414; G06V 10/95

(57) ABSTRACT

Provided is an image processing system including at least one processor configured to: acquire training data including, as an input portion, a training target image in which a training target document is shown and a training reference image in which a training reference document is shown and including, as a ground truth portion, ground truth information for processing the training target image so that a training target posture of the training target document in the training target image matches a training reference posture of the training reference document in the training reference image; and train, based on the training data, a learning model for image processing so that the ground truth information is output when the training target image and the training reference image are input.

### CROSS-REFERENCE TO RELATED APPLICATION

The present application claims priority from Japanese application JP2024-104042 filed on Jun. 27, 2024, the entire content of which is hereby incorporated by reference into the application.

### BACKGROUND

### 1. Field

The present disclosure relates to an image processing system, an image processing method, and an information storage medium.

### 2. Description of the Related Art

Hitherto, there has been known a technology which processes a document image in which a document is shown. For example, in WO 2020/008628 A1, there is described a technology of matching a feature point group extracted from a document image in which a document is shown and a feature point group extracted from a sample image in which the document is shown with each other, and processing the document image so that a positional relationship of the feature point group in the document image becomes or approaches a positional relationship of the feature point group in the sample image, to thereby correct a posture of the document in the document image.

### SUMMARY

However, with the technology as described in WO 2020/008628 A1, it is required to extract a large number of feature points from the document image, and hence a processing load on a computer which executes image processing increases. For example, when the image processing is to be executed on document images continuously generated by continuously capturing a document through use of a camera of a smartphone, a processing load on the smartphone increases with the technology of WO 2020/008628 A1. This point also applies to other computers other than the smartphone.

One object of the present disclosure is to reduce a processing load on a computer.

According to at least one embodiment of the present disclosure, there is provided an image processing system including at least one processor configured to: acquire training data including, as an input portion, a training target image in which a training target document is shown and a training reference image in which a training reference document is shown and as a ground portion, including, truth ground truth information for processing the training target image so that a training target posture of the training target document in the training target image matches a training reference posture of the training reference document in the training reference image; and train, based on the training data, a learning model for image processing so that the ground truth information is output when the training target image and the training reference image are input.

### BRIEF DESCRIPTION OF THE DRAWINGS

FIG. 1 is a diagram for illustrating an example of a hardware configuration of an image processing system.

FIG. 2 is a view for illustrating an example of a captured image uploaded by a user.

FIG. 3 is a diagram for illustrating an example of functions implemented in the image processing system.

FIG. 4 is a diagram for illustrating an example of a learning model.

FIG. 5 is a table for showing an example of a training database.

FIG. 6 is a diagram for illustrating an example of loss functions used at the time of training.

FIG. 7 is a diagram for illustrating an example of the training executed based on the loss functions.

FIG. 8 is a flowchart for illustrating an example of training processing.

FIG. 9 is a flowchart for illustrating an example of estimation processing.

FIG. 10 is a diagram illustrating an example of functions implemented in modification examples of the present disclosure.

### DETAILED DESCRIPTION OF THE INVENTION

### [1. Overall Configuration of Image Processing System]

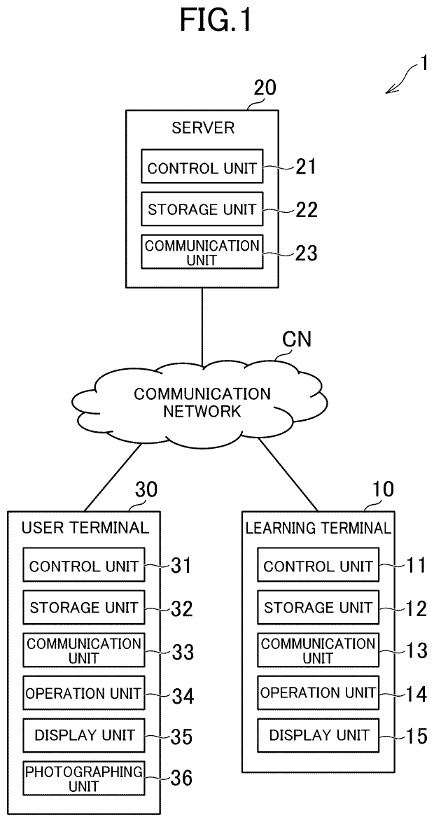

An example of an image processing system according to at least one embodiment of the present disclosure will now be described. FIG. 1 is a diagram for illustrating an example of a hardware configuration of the image processing system. For example, an image processing system 1 includes a learning terminal 10, a server 20, and a user terminal 30. The learning terminal 10, the server 20, and the user terminal 30 are each connectable to a communication network CN, such as the Internet or a local area network (LAN).

The learning terminal 10 is a computer which executes training of a learning model described below. For example, the learning terminal 10 is a personal computer, a server computer, a smartphone, or a tablet computer. The learning terminal 10 includes a control unit 11 (or controller), a storage unit 12 (or storage), a communication unit 13 (or communicator), an operation unit 14 (or operator), and a display unit 15 (or display). The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication. The operation unit 14 is an input device such as a touch panel. The display unit 15 is a liquid crystal display or an organic EL display.

The server 20 is a server computer which uses the trained learning model. The server 20 includes a control unit 21 (or controller), a storage unit 22 (or storage), and a communication unit 23 (or communicator). Hardware configurations of the control unit 21, the storage unit 22, and the communication unit 23 may be the same as those of the control unit 11, the storage unit 12, and the communication unit 13, respectively.

The user terminal 30 is a computer of a user. For example, the user terminal 30 is a personal computer, a smartphone, a tablet computer, or a wearable terminal. The user terminal 30 includes a control unit 31 (or controller), a storage unit 32 (or storage), a communication unit 33 (or communicator), an operation unit 34 (or operator), a display unit 35 (or display), and a photographing unit 36 (or camera). Hardware configurations of the control unit 31, the storage unit 32, the communication unit 33, the operation unit 34, and the display unit 35 are the same as those of the control unit 11, the storage unit 12, the communication unit 13, the operation unit 14, and the display unit 15, respectively. The photographing unit 36 includes at least one camera.

Programs stored in the storage units 12, 22, and 32 may be supplied through the communication network CN. Moreover, the learning terminal 10, the server 20, or the user terminal 30 may include a reading unit (for example, an optical disc drive or a memory card slot) for reading a computer-readable information storage medium or an input/output unit (for example, a USB port) for inputting/outputting data from/to an external device. For example, a program stored in the information storage medium may be supplied to the learning terminal 10, the server 20, or the user terminal 30 through the reading unit or the input/output unit.

Further, the image processing system 1 is only required to include at least one computer. For example, the image processing system 1 may include only the learning terminal 10 and the server 20. In this case, the user terminal 30 exists outside the image processing system 1. The image processing system 1 may include only the learning terminal 10. In this case, the server 20 and the user terminal 30 exist outside the image processing system 1. The image processing system 1 may include only the server 20. In this case, the learning terminal 10 and the user terminal 30 exist outside the image processing system 1. The image processing system 1 may include a computer not shown in FIG. 1.

### [2. Overview of Image Processing System]

In at least one embodiment, there is exemplified a case in which the image processing system 1 is applied to electronic Know Your Customer (eKYC). The eKYC is identity verification executed electronically. In the eKYC, an identity verification document (identity card) of a user is verified. The eKYC may be executed in any service. For example, the eKYC may be executed in a communication service, a financial service, a payment service, an electronic commerce service, an insurance service, or an administration service.

Referring to eKYC as an example, the user operates the user terminal 30 to capture an identity verification document through use of the photographing unit 36. The identity verification document may be of any type. The identity verification document may be a driver's license, an insurance card, a resident card, an individual number card, or a passport. The user terminal 30 generates a captured image showing the identity verification document captured by the photographing unit 36. The user terminal 30 uploads the captured image to the server 20.

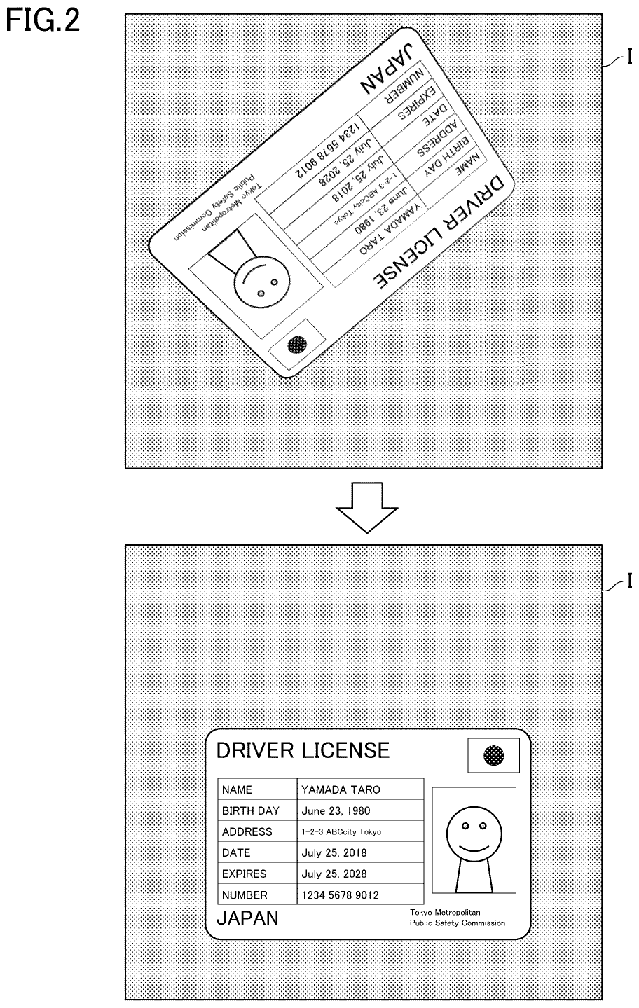

FIG. 2 is a view for illustrating an example of the captured image uploaded by the user. In at least one embodiment, it is assumed that the identity verification document is required to be captured from the front in order for the eKYC to be appropriately executed. When the user does not capture the identity verification document from the front, the identity verification document is not in an appropriate direction or is distorted such as shown in a captured image I on the upper side of FIG. 2. As shown in a captured image I on the lower side of FIG. 2, the identity verification document is required to be in an appropriate direction and not be distorted.

The “appropriate direction of the identity verification document” corresponds state in which an up-and-down direction (vertical direction or longitudinal direction) of the identity verification document in the captured image I and an up-and-down direction (vertical direction or longitudinal direction) of the captured image I match each other, or an angle formed therebetween is smaller than a predetermined angle (for example) 10°. In other words, the “appropriate direction of the identity verification document” corresponds to a state in which a left-and-right direction (horizontal direction or lateral direction) of the identity verification document in the captured image I and a left-and-right direction (horizontal direction or lateral direction) of the captured image I match each other, or an angle formed therebetween is smaller than a predetermined angle (for example) 10°.

The “distortion of the identity verification document” is a state in which a shape of a contour of the identity verification document in the captured image I and a shape of a contour of the actual identity verification document are different from each other. For example, when the user captures the identity verification document in an oblique direction, the identity verification document shown in the captured image I is distorted. When the contour of the identity verification document is a rectangle, a state in which the contour of the identity verification document shown in the captured image I is a trapezoid corresponds to the distortion of the identity verification document. When the contour of the identity verification document is a rectangle with round corners, a state in which the contour of the identity verification document shown in the captured image I is a trapezoid with round corners corresponds to the distortion of the identity verification document.

For example, when the server 20 receives the captured image I from the user terminal 30, the server 20 detects the identity verification document from the captured image I through publicly-known image processing such as contour extraction processing. In a state such as that of the captured image I on the upper side of FIG. 2, the server 20 may not be able to detect (or correctly detect) the identity verification document. In such cases, the server 20 may prompt the user to capture the identity verification document again. However, in this case, it takes time for the user, and hence convenience of the user decreases. The same applies to a case in which the identity verification document is detected on the user terminal 30 side.

For example, also in a case in which a person in charge of a business operation of the eKYC visually verifies the captured image I, the person in charge may fail to appropriately verify the identity verification document when the document is in the state such as that of the captured image I on the upper side of FIG. 2. In this case, it takes time for the person in charge to, for example, rotate the captured image I for the verification. Thus, also in the case in which the eKYC is executed through the visual verification of the person in charge, it is required to execute the eKYC for the captured image I in the state on the lower side of FIG. 2.

For example, the server 20 may extract a feature point group from the identity verification document shown in the captured image I and process the captured image I so that a positional relationship of the feature point group matches a positional relationship thereof in the identity verification document in the state appropriate for the eKYC. However, in this case, it is required for the server 20 to extract the group of a large number of feature points from the captured image I, and hence a processing load on the server 20 increases. Further, when the identity verification document is blurred or light is reflected on the identity verification document, the server 20 may not be able to appropriately extract the feature point group. The same applies to a case in which the feature point group is extracted on the user terminal 30 side.

Thus, the learning terminal 10 in at least one embodiment executes training of a learning model for acquiring a captured image I (for example, the captured image I on the lower side of FIG. 2) appropriate for the eKYC from a captured image I (for example, the captured image I on the upper side of FIG. 2) inappropriate for the eKYC. The server 20 acquires a captured image I (for example, the captured image I on the lower side of FIG. 2) appropriate for the eKYC based on the trained learning model even when a captured image I (for example, the captured image I on the upper side of FIG. 2) inappropriate for the eKYC is uploaded. As a result, the image processing system 1 can appropriately execute the eKYC while the processing load on the server 20 is reduced. Details of the image processing system 1 are now described.

### [3. Functions Implemented in Image Processing System]

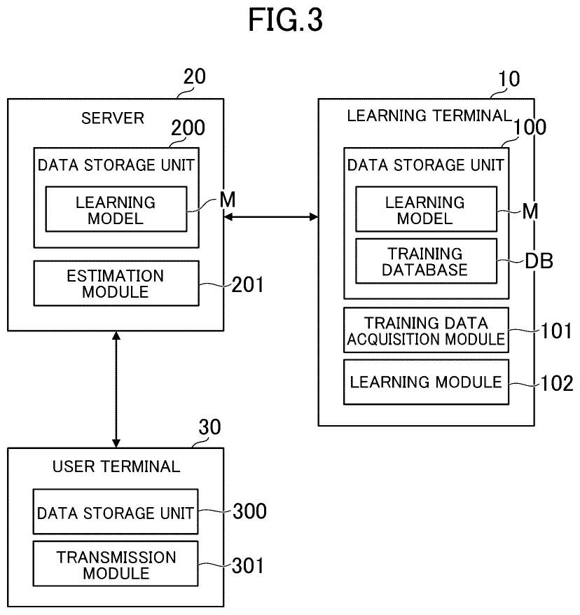

FIG. 3 is a diagram for illustrating an example of functions implemented in the image processing system 1 according to one or more embodiments.

### [3-1. Functions Implemented in Learning Terminal]

Referring to FIG. 3, the learning terminal 10 includes a data storage unit 100 (or data storage), a training data acquisition module 101 (or training data acquirer), and a learning module 102. The data storage unit 100 is implemented by the storage unit 12. The training data acquisition module 101 and the learning module 102 are implemented by the control unit 11.

### [Data Storage Unit]

The data storage unit 100 stores data required or used for training of a learning model M. The learning model M is a machine learning model used in image processing. A method itself for machine learning may be a publicly-known method. For example, the learning model M may be a convolutional neural network (for example, U-Net), a recurrent neural network, a generative adversarial network (GAN), a vision transformer, or a model based on another method.

For example, the data storage unit 100 stores the learning model M before being trained. The learning model M includes a program indicating processing to be executed on data input to the learning model M itself and parameters referred to by this program. The parameters of the learning model M may be the same as parameters used for publicly-known machine learning. For example, the parameters may be weights, biases, or other coefficients which are referred to by the program of the learning model M.

By way of example, the learning model M before being trained includes parameters having initial values. The parameters of the learning model M are adjusted through training described below. When the training is completed, the data storage unit 100 stores the trained learning model M. The learning model M before being trained may be overwritten with the trained learning model M, or the trained learning model M may be stored in the data storage unit 100 independently of the learning model M before being trained. In at least one embodiment, the trained learning model M is uploaded to the server 20.

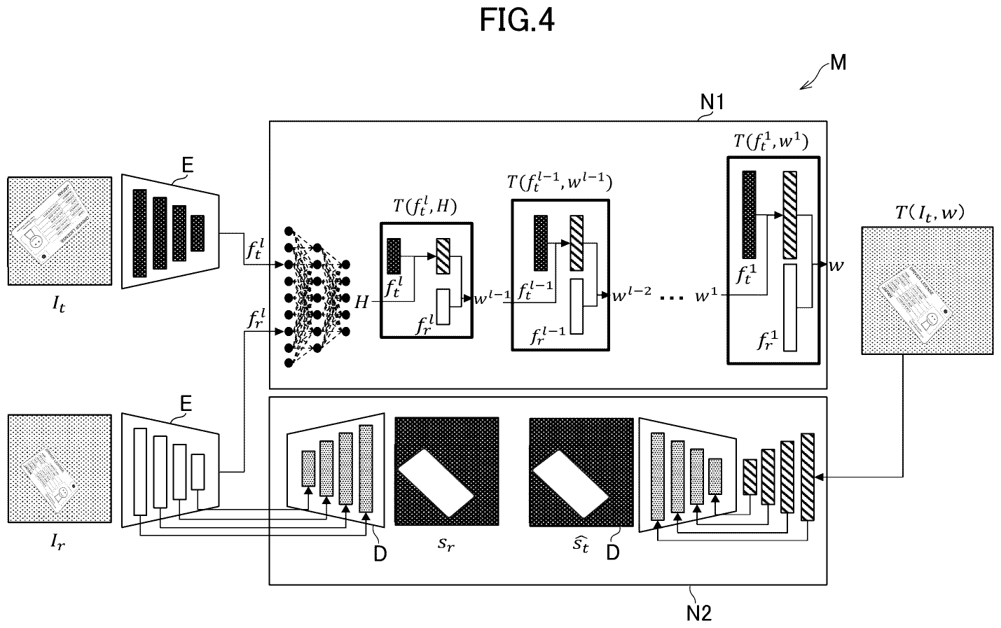

FIG. 4 is a diagram for illustrating an example of the learning model M. In at least one embodiment, there is exemplified a case in which the learning model M is a type of convolutional neural network. For example, the learning model M includes an encoder E, a decoder D, a first network N1, and a second network N2. In the example of FIG. 4, the decoder D is included in the second network N2, but it is understood that the decoder D may exist outside the second network N2 in one or more other embodiments. The encoder E may be included in the first network N1.

The encoder E calculates a feature of an input image input to the learning model M. The feature is information indicating a feature of the input image. For example, the feature is a feature map indicating the feature of the input image. The feature is sometimes also referred to as “embedded representation.” The encoder E refers to its own parameters, and executes convolution on the input image, to thereby calculate the feature. A calculation expression for the encoder E to execute the convolution on the input image may be a publicly-known calculation expression. The feature may be in any form, and may be, for example, expressed as a pixel value of each of a plurality of pixels as in an image, a vector, an array, a single numerical value, a combination of a plurality of numerical values, a matrix, or other forms.

For example, the encoder E may include a plurality of layers. Each layer of the encoder E calculates the features at levels different from one another. Each layer of the encoder E calculates the feature based on the features calculated by the layers prior to this layer and its own parameter. Each layer of the encoder E may also be referred to as a “convolution layer.” The encoder E may include another layer (for example, a layer of an activation function, a pooling layer, or a normalization layer) other than the convolutional layer. The configuration of the encoder E may be the same as that of a publicly-known encoder E. For example, the encoder E may be a module referred to as a “target-aware feature extractor.”

The target-aware feature extractor is an encoder E for extracting a feature useful for a specific task. As in at least one embodiment described above, when the image processing system 1 is used for the eKYC, the target-aware feature extractor appropriately extracts a feature of the identity verification document. A program and parameters included in the target-aware feature extractor may be the same as a publicly-known program and publicly-known parameters. The encoder E may be another encoder E other than the target-aware feature extractor.

In the at least one embodiment, two input images are input to the encoder E, and hence two encoders E are schematically illustrated in the example of FIG. 4, but it is assumed that the number of encoders E is actually one. However, the learning model M may include a plurality of encoders E in various other embodiments. For example, an encoder E for processing a certain input image and another encoder E for processing another input image may exist independently of each other. Moreover, in the example of FIG. 4, four layers are illustrated in the encoder E, but it is understood that the number of layers included in the encoder E is not limited to four. For example, the encoder E may include one, two, three, or five or more layers. The same applies to the decoder D. That is, in the example of FIG. 4, two decoders D are schematically illustrated, but it is assumed that the number of decoders D is actually one. However, the learning model M may include a plurality of decoders D in various other embodiments, and the number of layers of the decoder D is not limited to that in the example of FIG. 4.

In at least one embodiment, a target image and a reference image in which the identity verification document is shown are input as the input images to the learning model M. The target image is an image to be processed. The processing is image processing for changing the posture or orientation of the document shown in the target image. The processing may also be considered as shaping or deforming. For example, the processing may include translation, rotation, enlarging, reducing, shearing, =affine transformation, changing an arrangement of each pixel included in the input image, or any combination thereof.

The posture of the document is at least one of a direction, a shape, or a position of the document in the image. When a positional relationship between a viewpoint of a camera, the example of which is the photographing unit 36, and a document changes, at least one of the direction, the shape, or the position of the document in the image changes. Thus, the posture of the document may also be considered as a positional relationship between the viewpoint and the document. In at least one embodiment, the identity verification document as an example of the document is captured by the user. Hence, the identity verification document in a posture corresponding to the positional relationship between the photographing unit 36 and the identity verification document at the time of the capturing is shown in the target image.

The reference image is an image in which an identity verification document is shown in a predetermined posture. The predetermined posture is a posture desirable for the target image after being processed. The predetermined posture can also be considered as a posture serving as a target or an appropriate posture. The reference image can also be considered as an image serving as a sample in which the identity verification document is shown in the predetermined posture. The learning terminal 10 aims to create the learning model M which achieves such processing that the posture of the identity verification document shown in the target image becomes or approaches the posture of the identity verification document shown in the reference image.

In each of the target image and the reference image, a document of any type may be shown. That is, the document shown in each of the target image and the reference image is not limited to the identity verification document. “Identity verification document” as referred to herein can thus be understood as any document. For example, the document may be a quotation, a bill, a receipt, a contract, a report, a specification, a manual, a catalog, or another document. In at least one embodiment, the type of the document shown in the target image and the type of the document shown in the reference image are the same, but it is understood that one or more other embodiments are not limited thereto, and the types of those documents may be different from each other. For example, a driver's license may be shown in the target image and an insurance card may be shown in the reference image.

In at least one embodiment, the target image and the reference image at the time of training are referred to as “training target image” and “training reference image,” respectively. In FIG. 4, a flow of processing at the time of training is illustrated, and reference symbols Iₜ and Iᵣ denote the training target image and the training reference image, respectively. The target image and the reference image at the time of estimation are referred to as “estimation target image” and “estimation reference image,” respectively. When the training target image and the estimation target image are not particularly distinguished from each other, those images are simply referred to as “target images.” When the training reference image and the estimation reference image are not particularly distinguished from each other, those images are simply referred to as “reference images.”

When a target feature being a feature of the target image calculated by the encoder E and a reference feature being a feature of the reference image calculated by the encoder E are input to the first network N1, the first network N1 outputs processing information for processing the target image. In at least one embodiment, there is exemplified a case in which a conversion coefficient referred to in image processing which changes the arrangement of each pixel of the target image corresponds to the processing information. The target image is processed through the execution of the image processing of changing the arrangement of each pixel of the target image based on the processing information. When the target image is appropriately processed, the posture of the document in the target image after being processed becomes or approaches the posture of the document in the reference image.

For example, the first network N1 may be a network for identifying a correspondence between each pixel of the training target image Iₜ and each pixel of the training reference image Iᵣ. The correspondence between those pixels may also be referred to as “mapping.” When the correspondence between those pixels is identified (or based on the identified correspondence between those pixels), the posture of the training target document shown in the training target image Iₜ becomes or approaches the posture of the training reference document shown in the training reference image Iᵣ by changing the arrangement of each pixel of the training target image Iₜ based on the correspondence. When such processing is to be executed, the first network N1 can also be considered as a mapping network. Details of the processing of the first network N1 are described herein with reference to a function of the learning module 102.

The second network N2 outputs a segmentation map of an image to be processed based on the decoder D. The segmentation map is information indicating classification of each pixel of the image. In the at least one embodiment, there is exemplified a case in which the segmentation map is an image in which a classification result is visualized, but the segmentation map may be in another form other than the image. For example, the segmentation map indicates at least one of whether or not the document is shown in each pixel or a type of the document shown in each pixel.

For example, the second network N2 outputs, based on the target feature of the target image after being processed, a target segmentation map being the segmentation map of the target image. The second network N2 outputs, based on the reference feature of the reference image, a reference segmentation map being the segmentation map of the reference image. The second network N2 can also be considered as a segmentation network which outputs those segmentation maps. Details of the processing of the second network N2 are described herein with reference to the function of the learning module 102.

For example, the data storage unit 100 stores a training database DB in which a plurality of pieces of training data to be learned by the learning model M are stored. The training data includes an input portion to be input to the learning model M at the time of training and a ground truth portion (output portion) serving as ground truth at the time of training. The ground truth portion is not limited to the final output of the learning model M, and may be an output indicating an intermediate result calculated by the learning model M to obtain the final output. The ground truth portion may be a result obtained from the final output of the learning model M.

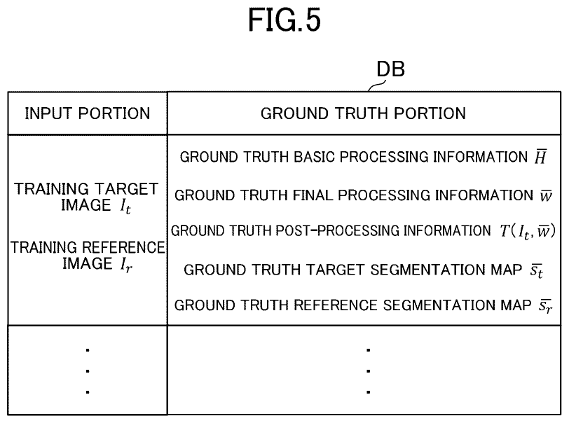

FIG. 5 is a table for showing an example of the training database DB. Referring to FIG. 5, the input portion of the training data is the training target image Iₜ and the training reference image Iᵣ. The training target image Iₜ shows the training target document in a first posture. The training reference image Iᵣ shows the training target document in a second posture. The second posture is a posture different from the first posture. The second posture can also be considered as an appropriate posture, a posture serving as ground truth, or a desired posture. The learning model M aims to process the training target document in the training target image Iₜ from the first posture to the second posture.

For example, the first posture of the training target document shown in a certain training target image Iₜ and the first posture of the training target document shown in another training target image Iₜ may be different from each other. The first posture of the training target document shown in the training target image Iₜ may be a posture inappropriate for the eKYC or may be a posture appropriate for the eKYC. The second posture of the training reference document shown in a certain training reference image Iᵣ and the second posture of the training reference document shown in another training reference image Iᵣ may be different from each other. The second posture of the training reference document shown in the training reference image Iᵣ may be a posture appropriate for the eKYC or may not be a posture appropriate for the eKYC. Iₜ is assumed that, in order to cause the learning model M to learn various postures, training data including training target images Iₜ and training reference images Iᵣ in various postures are stored in the training database DB.

The ground truth portion of the training data may include, as ground truth information, the training target image Iₜ itself after being processed, the processing information used for the processing of the training target image Iₜ, or other information. In at least one embodiment, there is exemplified a case in which the ground truth portion of the training data is ground truth processing information, which is the processing information serving as ground truth. The ground truth portion of the training data may include other information other than the ground truth processing information.

In the example of FIG. 5, the ground truth portion of the training data includes, as the ground truth processing information, ground truth basic processing information and ground truth final processing information. The ground truth portion of the training data includes, as other information, a ground truth target segmentation map and a ground truth reference segmentation map. In the example of FIG. 5, a bar is attached to reference symbols of those four pieces of information. In the description given below, the bar of each reference symbol is expressed within parentheses, such as H (bar), w (bar), sᵣ (bar), or sₜ (bar). In the at least one embodiment, the ground truth portion of the training data also includes ground truth post-processing information T(Iₜ, w (bar)). Details of these five pieces of information are described below.

The data stored in the data storage unit 100 is not limited to the above-mentioned example. For example, the data storage unit 100 may store a program indicating processing at the time of training. In this program, a calculation expression of a loss function may be defined.

### [Training Data Acquisition Module]

The training data acquisition module 101 acquires the training data including, as the input portion, the training target image Iₜ in which the training target document is shown and the training reference image Iᵣ in which the training reference document is shown. The training data also includes, as the ground truth portion, the ground truth information for processing the training target image Iₜ so that the training target posture of the training target document in the training target image Iₜ matches the training reference posture of the training reference document in the training reference image Iᵣ. In at least one embodiment, the training data is stored in the training database DB, and hence the training data acquisition module 101 acquires the training data from the training database DB. The training data stored in the training database DB is assumed to have been prepared by a creator (for example, a person who operates the learning terminal 10) who creates the learning model M.

When the training data is stored in another database other than the training database DB, the training data acquisition module 101 may only be required to acquire the training data from the other database. When the training data is stored in another computer other than the learning terminal 10 or an information storage medium, the training data acquisition module 101 may only be required to acquire the training data from the other computer or the information storage medium. The training data acquisition module 101 can acquire any number of pieces of training data. For example, the training data acquisition module 101 may acquire the whole or a part of the training data stored in the training database DB. The training data acquisition module 101 may repeat the acquisition of the training data until a value of each loss function described below becomes sufficiently small (e.g., at or below a predetermined or threshold value).

### [Learning Module]

The learning module 102 trains, based on the training data, the learning model M for image processing so that the ground truth information is output when the training target image Iₜ and the training reference image Iᵣ are input. For example, the learning module 102 inputs, to the learning model M, the training target image Iₜ and the training reference image Iᵣ being the input portion of the training data. The learning model M calculates, based on the parameters in the current state, a training target feature of the training target image Iₜ and a training reference feature of the training reference image Iᵣ. The learning model M calculates, based on the parameters in the current state, the training target feature of the training target image Iₜ, and the training reference feature of the training reference image Iᵣ, the processing information (for example, basic processing information H and final processing information “w” described below) for processing the training target image Iₜ, and outputs this processing information.

For example, the learning module 102 calculates a loss based on the output (for example, the basic processing information H and the final processing information “w” described below) of the learning model M, the ground truth portion (for example, ground truth basic processing information H (bar) and ground truth final processing information “w” (bar) described below) of the training data, and the predetermined loss function. The learning module 102 adjusts the parameters of the learning model M such that the loss decreases, to thereby execute the training of the learning model M. When the plurality of pieces of training data are successively acquired by the training data acquisition module 101, the learning module 102 repeats, for each piece of training data, processing of inputting the training target image Iₜ and the training reference image Iᵣ included in the piece of training data to the learning model M, acquiring the output from the learning model M, calculating the loss based on the loss function, and adjusting the parameters such that the loss decreases.

The learning module 102 may execute the training of the learning model M based on a publicly-known training algorithm employed in a method of machine learning. For example, the learning module 102 may cause the learning model M to learn the training data based on error back propagation, gradient descent, adaptive moment (ADAM) estimation, momentum method, a method that uses a discriminator and a generator employed in a generative adversarial network (GAN), or another method. The learning module 102 may repeat the training of the learning model M until the loss falls below a threshold value, or may repeat the training of the learning model M until the number of times of training reaches a predetermined number of times. The learning module 102 may repeatedly use the same training data for the training.

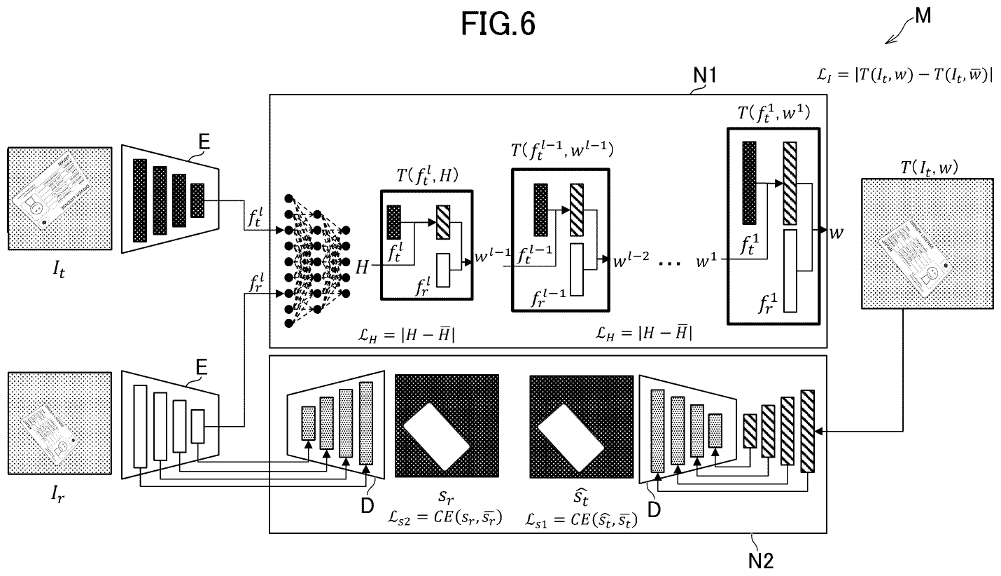

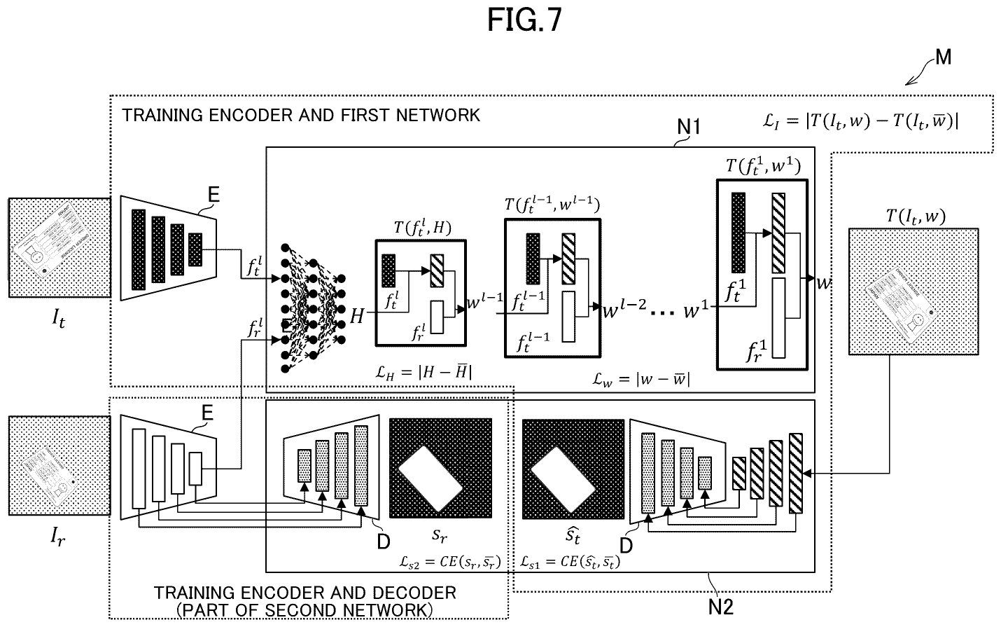

FIG. 6 is a diagram for illustrating an example of the loss functions used at the time of training. FIG. 7 is a diagram for illustrating an example of the training executed based on the loss functions. In at least one embodiment, the learning model M includes the encoder E which calculates a training target feature fₜ^{l} of the training target image Iₜ and a training reference feature fᵣ^{l} of the training reference image Iᵣ, and the first network N1 which calculates the processing information relating to the processing of the training target image Iₜ based on the training target feature fₜ^{l} and the training reference feature fᵣ^{l}. The learning module 102 trains the encoder E and the first network N1 of the learning model M.

The reference symbol “1” (i.e., lower case L) of the training target feature fₜ^{l} and the training reference feature fᵣ^{l} indicates the number of layers included in the encoder E. In at least one embodiment, the encoder E includes four layers, and the value of the reference symbol “l” is 4. As described above, the encoder E can include any number of layers, and hence the numerical value of “l” is not limited to 4. Each of the training target feature fₜ^{l} and the training reference feature fᵣ^{l} is a feature output by the last layer (the fourth layer in at least one embodiment) of the encoder E. Training target features fₜ¹ to fₜ^{l-1} and training reference features fᵣ^{l} to fᵣ^{l-1} are calculated by previous layers (the first layer to the l−1-th layer) of the last layer of the encoder E.

In at least one embodiment, as illustrated in FIG. 4, FIG. 6, and FIG. 7, the encoder E includes the plurality of layers which calculate the training target features fₜ¹ to fₜ^{l} and the training reference features fᵣ¹ to fᵣ^{l}. The encoder E calculates, based on a parameter(s) of each of the plurality of layers, the training target features fₜ¹ to fₜ^{l} and the training reference features fᵣ^{l} to fᵣ^{l}. For example, the first layer of the encoder E calculates the training target feature fₜ¹ based on the training target image Iₜ and the parameter of the first layer. The second layer of the encoder E calculates the training target feature fₜ² based on the training target feature fil and the parameter of the second layer. As described above, each layer calculates the training target feature fₜ^{k} based on the training target feature fₜ^{k-1} calculated by the previous layer of the layer and its own parameter(s). The last layer outputs the final training target feature fₜ^{l}. The symbol “k” is any numerical value of from 1 to “l”. When “k” is 1, a layer does not exist before and the training target feature fₜ^{k-1} does not exist, and hence the calculation of the first layer described above is executed.

For example, the first layer of the encoder E calculates the training reference feature fᵣ^{l} based on the training reference image Iᵣ and the parameter of the first layer. The second layer of the encoder E calculates the training reference feature fᵣ² based on the training reference feature fᵣ^{l} and the parameter of the second layer. Subsequently, each of the third and subsequent layers of the encoder E calculates the training reference feature fᵣ^{k} based on the training reference feature fᵣ^{k-1} calculated by the previous layer of the layer and its own parameter(s). The last layer outputs the final training reference feature fᵣ^{l}.

As illustrated in FIG. 6, the first network N1 calculates, based on the training target feature fₜ^{l} and the training reference feature fᵣ^{l}, the basic processing information H being the basic processing information calculated first, pieces of intermediate processing information w^{l-1} to w¹ being the processing information calculated intermediately, and the final processing information “w” being the processing information output finally. For example, the first network N1 calculates, for each layer, the processing information based on the training target feature fₜ^{k} and the training reference feature fᵣ^{k} calculated by this layer, to thereby calculate final processing information “w” being a final version of the processing information. A calculation method for each of the basic processing information H, the pieces of intermediate processing information w^{l-1} to w¹, and the final processing information “w” according to one or more embodiments will now be described.

First, the calculation method for the basic processing information H is described. The first network N1 calculates the basic processing information H being the processing information calculated based on the training target feature fₜ^{l} and the training reference feature fᵣ^{l} calculated by the last layer out of the plurality of layers. The basic processing information H is information indicating a correspondence or a difference between the training target feature fₜ^{l} and the training reference feature fᵣ^{l} (for example, a correspondence between the pixels in the feature map or a correspondence between a pixel of a certain feature map and a pixel of another corresponding feature map). The basic processing information H can also be considered as information for causing the training target feature fₜ^{l} to approach the training reference feature fᵣ^{l}. The basic processing information H may be in any form, and may be, for example, a vector, a matrix, a single numerical value, a combination of a plurality of numerical values, an array, or other forms.

For example, the first network N1 includes an initial posture network (in FIG. 4, FIG. 6, and FIG. 7, a network disposed between the training target feature fₜ^{l} and the training reference feature fᵣ^{l} and the basic processing information H) which calculates the basic processing information H when the training target feature fₜ^{l} and the training reference feature fᵣ^{l} are input. The initial posture network includes a plurality of neurons. The initial posture network calculates a difference between the training target feature fₜ^{l} and the training reference feature fᵣ^{l}, and inputs the difference to a neuron. When the neuron receives the difference, the neuron calculates a weighted sum, for example, adds a bias as required, and passes the calculation result to another neuron. When a plurality of neurons successively execute the calculation, the basic processing information H is output as a final output. The initial posture network calculates the basic processing information H through the calculation of each neuron based on the training target feature fₜ^{l}, the training reference feature fᵣ^{l}, and its own parameters. Parameters of each neuron are also adjusted through the training.

For example, the ground truth processing information includes the ground truth basic processing information H (bar) being the basic processing information serving as the ground truth. The learning module 102 calculates a basic processing information loss L_{H} based on the basic processing information H calculated at the time of training and the ground truth basic processing information H (bar), and trains the learning model M based on this basic processing information loss L_{H}. In at least one embodiment, a calculation expression for the basic processing information loss L_{H} is as given by Expression 1 below. It is understood, however, that one or more other embodiments are not limited thereto and the calculation expression for the basic processing information loss L_{H} may be another expression other than Expression 1. For example, the learning module 102 may multiply at least one of the basic processing information H or the ground truth basic processing information H (bar) by a coefficient, and then calculate a difference therebetween as the basic processing information loss L_{H}.

$${ℒ}_{H} = \vert H - \overline{H} \vert \qquad [ Expression 1 ]$$

Description is now given of the calculation method for each of the pieces of intermediate processing information w^{l-1} to w² and the final processing information “w”. The first network N1 calculates, for each layer starting from a layer later in sequence out of the plurality of layers, the pieces of intermediate processing information w^{l-1} to w¹ being an intermediate version of the processing information based on the training target feature fₜ^{l} and the training reference feature fᵣ^{l} calculated by this layer, to thereby calculate final processing information “w” being a final version of the processing information. The sequence of the layers is a place (value of the numerical value of “k” described above) in the sequence of the layers in the decoder D. In at least one embodiment, the decoder D has the four layers, and hence there exists the first place to the fourth place in the sequence.

For example, the first network N1 calculates a training target feature T(fₜ^{l}, H) after being processed based on the training target feature fₜ^{l} calculated by the last layer (for example, the fourth layer) and the basic processing information H. The training target feature T(fₜ^{l}, H) after being processed is the training target feature fₜ^{l} after the calculation as given by a calculation expression T is executed. The training target feature T(fₜ^{l}, H) after being processed is a calculation result obtained by assigning the training target feature fₜ^{l} and the basic processing information H to the predetermined calculation expression T. The calculation expression T has two arguments. Here, the first argument is the training target feature fₜ^{l}. The second argument is the basic processing information H.

For example, when the first argument of the calculation expression T is information in an image form such as the feature map and the second argument is information for changing the arrangement of each pixel, the information obtained through use of the calculation expression T is information in an image form in which the arrangement of each pixel is changed through the second argument. The calculation expression T may be any calculation expression, and for example, may be an expression which applies, based on any coefficient, addition, subtraction, multiplication, or division to the first argument and the second argument. When the calculation expression T includes a certain coefficient, this coefficient may be one of the parameters adjusted through the training. That is, the coefficient of the calculation expression T may also be adjusted through the training. The calculation expression T may be a calculation expression employed in a method (method of spatially converting a feature of data such as an image) referred to as “feature warping.”

For example, first network N1 calculates the intermediate processing information w^{l-1} based on the training target feature T(fₜ^{l}, H) after being processed and the training reference feature fᵣ^{l}. The intermediate processing information w^{l-1} is information indicating a correspondence or a difference between the training target feature T(fₜ^{l}, H) after being processed (for example, a feature map after the feature map indicated by the training target feature fₜ^{l} is processed through use of the basic processing information H) and the training reference feature fᵣ^{l}. The training target feature T(fₜ^{l}, H) after being processed approaches, through the basic processing information H, the training reference feature fᵣ^{l} more with respect to the training target feature fₜ^{l}. The intermediate processing information w^{l-1} may be in any form, and may be, for example, a vector, a matrix, a single numerical value, a combination of a plurality of numerical values, an array, or in another form. The same applies to the pieces of intermediate processing information w^{l-2} to w¹.

For example, the first network N1 calculates, based on a calculation expression that uses a method referred to as “Cost Volume” of identifying a correspondence between two images, the intermediate processing information w^{l-1} indicating the correspondence or the difference between the training target feature T(fₜ^{l}, H) after being processed and the training reference feature fᵣ^{l}. The intermediate processing information w^{l-1} may indicate a correspondence between pixels of an image indicated by the training target feature T(fₜ^{l}, H) after being processed and the pixels of the image indicated by the training reference feature fᵣ^{l}. The first network N1 may calculate the intermediate processing information w^{l-1} based on a calculation expression that uses another method other than Cost Volume. For example, the first network N1 may calculate, as the intermediate processing information w^{l-1}, a difference between the training target feature T(fₜ¹, H) after being processed and the training reference feature fᵣ^{l}.

For example, the first network N1 calculates the training target feature T(fₜ^{l-1}, w^{l-1}) after being processed based on the intermediate processing information w^{l-1} and the training target feature fₜ^{l-1} calculated by the second last layer (for example, the third layer). The calculation expression T is as described above. The first network N1 calculates the intermediate processing information w^{l-2} based on the training target feature T(fₜ^{l-1}, w^{l-1}) after being processed and the training reference feature fᵣ^{l-1}. A calculation expression to be used for the calculation of the intermediate processing information w^{l-2} may be the same as the calculation expression to be used for the calculation of the intermediate processing information w^{l-1}. The calculation of the intermediate processing information w^{l-2} may also use the “Cost Volume” method.

Subsequently, in the same manner, the first network N1 successively executes the same calculation from a layer later in the sequence of the layers of the encoder E, to thereby execute the calculation up to the intermediate processing information w¹. The first network N1 calculates the training target feature T(fₜ^{l}, w^{l}) after being processed based on the intermediate processing information w¹ and the training target feature fₜ¹ calculated by the first layer (first layer). The first network N1 calculates the final processing information “w” based on the training target feature T(fₜ¹, w¹) after being processed and the training reference feature fᵣ¹. A calculation expression to be used for the calculation of the final processing information “w” may be the same as the calculation expression to be used for the calculation of the pieces of intermediate processing information w^{l-1} to w¹. The calculation of the final processing information “w” may also use the “Cost Volume” method.

For example, the ground truth processing information includes the ground truth final processing information “w” (bar) being the final processing information “w” serving as the ground truth. The learning module 102 calculates a final processing information loss Lw based on the final processing information “w” calculated at the time of training and the ground truth final processing information “w” (bar), and trains the learning model M based on this final processing information loss L_{w}. In at least one embodiment, a calculation expression for the final processing information loss L_{w} may be as given by Expression 2 below. It is understood, however, that one or more other embodiments are not limited thereto, and the calculation expression for the final processing information loss L_{w} may be another expression other than Expression 2. For example, the learning module 102 may multiply at least one of the final processing information “w” or the ground truth final processing information “w” (bar) by a coefficient, and then calculate a difference therebetween as the final processing information loss L_{w}.

$${ℒ}_{w} = \vert w - \overline{w} \vert \qquad [ Expression 2 ]$$

For example, the ground truth information includes ground truth post-processing information T(Iₜ, w (bar)) relating to training target image T(Iₜ, w) after being processed serving as the ground truth. The learning module 102 calculates the post-processing loss L_{I} based on the training target image T(Iₜ, W) processed based on the processing information calculated by the first network N1 at the time of training and the ground truth post-processing information T(Iₜ, W (bar)), and trains the learning model M based on this post-processing loss L_{I}. When the final processing information “w” indicates the Cost Volume, the learning module 102 converts the position of each pixel of the training target image Iₜ to a position indicated by the final processing information “w”, to thereby acquire the training target image T(Iₜ, w) after being processed. When the final processing information “w” is a conversion coefficient of affine transformation or the like, the learning module 102 executes conversion corresponding to the final processing information “w” on the training target image Iₜ, to thereby acquire the training target image T(Iₜ, w) after being processed.

In at least one embodiment, a calculation expression for the post-processing loss L_{I} may be as given by Expression 3 below. It is understood, however, that one or more other embodiments are not limited thereto, and the calculation expression for the post-processing loss L_{I} may be another expression other than Expression 3. For example, the learning module 102 may multiply at least one of a pixel value of each pixel of the training target image T(Iₜ, w) or a pixel value of each pixel of the ground truth post-processing information T(Iₜ, w (bar)) by a coefficient, and then calculate a difference therebetween as the post-processing loss L_{I}. For example, Expression 3 may be a difference in pixel value between each pixel of the training target image T(Iₜ, w) after being processed and each pixel of the ground truth post-processing information T(Iₜ, w (bar)) or may indicate, when a label indicating whether or not each pixel indicates a document is assigned, whether the label of each pixel matches.

$${ℒ}_{I} = \vert T ( {I}_{t} , w ) - T ( {I}_{t} , \overline{w} ) \vert \qquad [ Expression 3 ]$$

As described above, in at least one embodiment, the ground truth information includes the ground truth processing information being the processing information serving as the ground truth. While an example of the ground truth processing information includes two pieces of information being the ground truth basic processing information H (bar) and the ground truth final processing information “w” (bar), it is understood that one or more other embodiments are not limited thereto. For example, only one of the ground truth basic processing information H (bar) or the ground truth final processing information “w” (bar) may be used as the ground truth processing information in another embodiment. The learning module 102 calculates the processing information loss based on the processing information calculated by the first network N1 at the time of training and the ground truth processing information, and trains the learning model M based on this processing information loss.

While an example of the processing information loss includes two losses being the basic processing information loss L_{H} and the final processing information loss L_{w}, it is understood that one or more other embodiments are not limited thereto. For example, only one of the basic processing information loss L_{H} or the final processing information loss L_{w} may be used as the processing information loss in another embodiment. Moreover, for example, for the intermediate processing information w^{l-1} to w^{l}, the intermediate processing information serving as the ground truth may be prepared, and the learning module 102 may calculate a loss based on each of the pieces of intermediate processing information w^{l-1} to w^{l} obtained at the time of training and the intermediate processing information serving as the ground truth, and may execute the training of the learning model M based on the obtained losses.

For example, the learning model M may include a decoder D which outputs the segmentation map and another portion which processes the training target image Iₜ. The other portion is a portion other than the decoder D. For example, the other portion may be the encoder E and the first network N1. In at least one embodiment, the decoder D is included in the second network N2, and hence there is exemplified a case in which the second network N2 generates the segmentation map. In the example of FIG. 6, the decoder D in a U-net is illustrated, but the decoder D may be a decoder D in a convolutional network other than the U-net, or a network in another machine learning method other than the convolutional neural network in various other embodiments.

For example, the decoder D executes up-sampling based on each of the training target features T(fₜ^{l}, H) to T(fₜ¹, w¹) after being processed. The training target image T(Iₜ, w) after being processed may be input to the encoder E, and the training target feature after being processed calculated by each layer of the encoder E may be input to the decoder D. The decoder D may also include a plurality of layers as in the encoder E. Each layer of the decoder D executes up-sampling based on its own parameter(s), and outputs the segmentation map. Through the up-sampling, resolution of each of the training target features T(fₜ^{l}, H) to T(fₜ¹, w¹) after being processed is restored to the original resolution. The decoder D may execute processing of restoring the resolution to the original resolution through a method called “transposed convolution” or “up-pooling” other than the up-sampling.

In FIG. 6, reference symbol “s” denotes the segmentation map. Reference symbol obtained by adding hat to sₜ denotes a segmentation map generated from the training target features T(fₜ^{l}, H) to T(fₜ¹, w¹) after being processed. This reference symbol is hereinafter written within parentheses, such as sₜ (hat). The reference symbol sᵣ is a segmentation map generated from the training reference features fᵣ^{l} to fᵣ¹. The segmentation map of the processed training target image T(Iₜ, w) is referred to as “training target segmentation map sₜ (hat).” As described above, the training target segmentation map sₜ (hat) may be acquired by inputting the processed training target image T(Iₜ, w) to the encoder E.

For example, the learning module 102 calculates the first segmentation map loss Lₛ₁ based on the training target segmentation map sₜ (hat) being the segmentation map of the processed training target image T(Iₜ, w) being the training target image Iₜ processed through use of the other portion described above and the first ground truth segmentation map sₜ (bar) serving as the ground truth of this processed training target image T(Iₜ, w), and trains the learning model M based on this first segmentation map loss Lₛ₁. In at least one embodiment, a calculation expression for the first segmentation map loss Lₛ₁ is as given by Expression 4 below. CE of Expression 4 is cross entropy. It is understood, however, that one or more other embodiments are not limited thereto, and the calculation expression for the first segmentation map loss Lₛ₁ may be another expression other than Expression 4. For example, the first segmentation map loss Lₛ₁ may be calculated through another calculation method other than cross entropy, such as mean square error.

$${ℒ}_{s 1} = CE ( , \overline{{s}_{t}} ) \qquad [ Expression 4 ]$$

For example, the decoder D may output the training target segmentation map sₜ (hat) indicating the posture and the type of the training target document in the training target image Iₜ. In the training target segmentation map sₜ (hat), the position and the type of the training target document shown in the training target image T(Iₜ, w) after being processed are indicated. In the example of FIG. 6, the type of the training target document is indicated in a color schematically expressed as a design or presence or absence thereof. For example, a classification result of the identity verification document is indicated by color, such as red for the driver's license, blue for the insurance card, and yellow for the individual number card. Of the training target segmentation map sₜ (hat), a portion other than the training target document is in a predetermined background color. The portion (portion in red or the like) other than the background color is a portion of the training target image T(Iₜ, w) after being processed in which the identity verification document is shown.

For example, the first ground truth segmentation map sₜ (bar) may indicate the posture and the type serving as the ground truth. Of the first ground truth segmentation map sₜ (bar), the training target document portion serving as the ground truth indicates the color of the type serving as the ground truth. The first segmentation map loss Lₛ₁ indicates a difference between the pixel value (color) of each pixel indicated by the training target segmentation map sₜ (hat) and the pixel value (color) of each pixel indicated by the first ground truth segmentation map sₜ (bar). As the difference becomes smaller, the training target image T(Iₜ, w) after being processed becomes closer to an image showing a result required to be finally obtained.

For example, the decoder D executes the up-sampling based on each of the training reference features fᵣ^{l} to fᵣ¹ of the training reference image Iᵣ. Through the up-sampling, the resolution of each of the training reference features fᵣ^{l} to fᵣ¹ is restored to the original resolution. The training reference image Iᵣ may be input to the encoder E, and the training reference feature after being processed or calculated by each layer of the encoder E may be input to the decoder D. The learning module 102 calculates a second segmentation map loss Lₛ₂ based on a training reference segmentation map sᵣ being a segmentation map of the training reference image Iᵣ and a second ground truth segmentation map sᵣ (bar) serving as ground truth of this training reference image Iᵣ, and trains the learning model M based on this second segmentation map loss Lₛ₂. In at least one embodiment, a calculation expression for the second segmentation map loss Lₛ₂ may be as given by Expression 5 below. CE of Expression 5 is cross entropy. It is understood, however, that one or more other embodiments are not limited thereto, and the calculation expression for the second segmentation map loss Lₛ₂ may be another expression other than Expression 5. For example, the second segmentation map loss Lₛ₂ may be calculated through another calculation method other than cross entropy, such as mean square error.

$${ℒ}_{s 2} = CE ( {s}_{r} , \overline{{s}_{r}} ) \qquad [ Expression 5 ]$$

For example, the decoder D may output the training reference segmentation map sᵣ indicating the posture and the type of the training reference document in the training reference image Iᵣ. In the training reference segmentation map sᵣ, the position and the type of the training reference document shown in the training reference image Iᵣ are indicated. In the example of FIG. 6, the type of the training reference document is shown in a color schematically expressed as a design. The meaning of the color may be the same as that of the type of the training target document. Of the training reference segmentation map sᵣ, a portion other than the training reference document is in a predetermined background color. The portion (portion in red or the like) other than the background color is a portion of the training reference image Iᵣ in which the identity verification document is shown.

For example, the second ground truth segmentation map sr indicates the posture and the type serving as the ground truth. Of the second ground truth segmentation map sᵣ, the training reference document portion serving as the ground truth indicates the color of the type serving as the ground truth. The second segmentation map loss Lₛ₂ indicates a difference between the pixel value (color) of each pixel indicated by the training reference segmentation map sᵣ and the pixel value (color) of each pixel indicated by the second ground truth segmentation map sᵣ (bar). As the difference between those pixel values becomes smaller, accuracy of the training reference segmentation map sᵣ becomes higher.

As described above, the learning module 102 in at least one embodiment calculates the basic processing information loss L_{H}, the final processing information loss L_{w}, the post-processing loss L_{I}, the first segmentation map loss Lₛ₁, and the second segmentation map loss Lₛ₂. For example, the learning module 102 may calculate a total loss being a sum thereof, and execute the training of the learning model M such that the total loss decreases. The method itself of executing, by the learning module 102, the training of the learning model M based on the losses may be the same as a publicly-known method (for example, gradient descent). For example, the learning module 102 may execute the training of the learning model M based on a gradient of the total loss.

In the example of FIG. 7, the learning module 102 executes the training of the encoder E and the first network N1 based on the basic processing information loss L_{H}, the final processing information loss L_{w}, the post-processing loss L_{I}, and the first segmentation map loss Lₛ₁. For example, the learning module 102 executes the training of the encoder E and the first network N1 such that a total loss obtained by totaling the basic processing information loss L_{H}, the final processing information loss L_{w}, the post-processing loss L_{I}, and the first segmentation map loss Lₛ₁ decreases. In the total loss, a coefficient may be set for at least one of the basic processing information loss L_{H}, the final processing information loss L_{w}, the post-processing loss L_{I}, or the first segmentation map loss Lₛ₁.

In the example of FIG. 7, the learning module 102 executes the training of the encoder E and the decoder D based on the second segmentation map loss Lₛ₂. For example, the learning module 102 may execute the training of the encoder E and the decoder D based on a gradient of the second segmentation map loss Lₛ₂. The learning module 102 may execute the training of only one of the encoder E or the decoder D based on the second segmentation map loss Lₛ₂.

The learning module 102 may calculate only a part of the basic processing information loss L_{H}, the final processing information loss L_{w}, the post-processing loss L_{I}, the first segmentation map loss Lₛ₁, and the second segmentation map loss Lₛ₂, and train the learning model M based on the total loss based only on this part. The learning module 102 may calculate only the basic processing information loss L_{H}, and train the learning model M based only on the basic processing information loss L_{H}. The learning module 102 may calculate only the final processing information loss L_{w}, and train the learning model M based only on the final processing information loss L_{w}. The learning module 102 may calculate only the post-processing loss L_{I}, and train the learning model M based only on the post-processing loss L_{I}. The learning module 102 may calculate only the first segmentation map loss Lₛ₁, and train the learning model M based only on the first segmentation map loss Lₛ₁.

### [3-2. Functions Implemented in Server]

Referring to the example of FIG. 3, the server 20 includes a data storage unit 200 and an estimation module 201. The data storage unit 200 is implemented by the storage unit 22. The estimation module 201 is implemented by the control unit 21.

### [Data Storage Unit]

The data storage unit 200 (or data storage) stores data required or used for the processing of the estimation target image. For example, the data storage unit 200 stores the trained learning model M. The data storage unit 200 may store an estimation reference image in which the estimation reference document in the posture appropriate for the eKYC is shown. For example, in the estimation reference image, the identity verification document captured from the front as in the captured image I on the lower side of FIG. 2 may be shown. The estimation reference image is only required to show the identity verification document in the posture required to be obtained after the processing of the estimation target image, and is not limited to the identity verification document captured from the front. For example, when the estimation target image is to be purposely processed so that a predetermined distortion occurs, the identity verification document having the predetermined distortion may be shown in the estimation reference image.

### [Estimation Module]

The estimation module 201 (or estimator) inputs, to the trained learning model M, the estimation target image in which an estimation target document is shown and the estimation reference image in which the estimation reference document is shown. Further, the estimation module 201 acquires a processed estimation target image being the estimation target image processed so that an estimation target posture of the estimation target document matches an estimation reference posture of the estimation reference document. The processing executed when the estimation target image and the estimation reference image are input to the trained learning model M is the same as the processing executed when the training target image and the training reference image are input to the learning model M at the time of training. From the above description of the processing of the learning model M given with respect to the function of the learning module 102, processing obtained by replacing “training” with “estimation” in the processing after the training target image and the training reference image are input to the learning model M may be executed at the time of estimation.

For example, the estimation module 201 inputs the estimation target image and the estimation reference image to the learning model M including the trained encoder E and first network N1 and acquires the processed estimation target image. The estimation module 201 acquires, based on the decoder D, an estimation target segmentation map being the segmentation map corresponding to the processed estimation target image processed through use of the other portion. Those pieces of processing may also be the same as the processing at the time of training. The estimation module 201 may estimate which identity verification document has been captured in accordance with the color indicated in the estimation target segmentation map. Further, the estimation module 201 may output a result of the estimation to a user or a person in charge of the eKYC. The server 20 may execute publicly-known image processing for the eKYC on the estimation target image processed by the estimation module 201.

For example, when the estimation module 201 inputs the estimation target image and the estimation reference image to the learning model M, the encoder E of the learning model M calculates, based on the parameters adjusted through the training, an estimation target feature being a feature of the estimation target image and an estimation reference feature being a feature of the estimation reference image. When the encoder E includes a plurality of layers, the estimation target feature and the estimation reference feature are calculated by each of the plurality of layers. The first network N1 of the learning model M calculates the intermediate processing information based on the estimation target feature and the estimation reference feature calculated by the last layer, and then successively calculates the intermediate processing information based on the estimation target feature and the estimation reference feature calculated by each layer. The first network N1 outputs the final processing information being the final version.

For example, the estimation module 201 processes the estimation target image based on the final processing information, to thereby acquire the estimation target image after being processed. In at least one embodiment, the estimation target image after being processed is an image obtained by changing the arrangement of each pixel of the estimation target image based on the final processing information. The posture of the estimation target document shown in the estimation target image after being processed becomes the same as or approaches the posture of the estimation reference document shown in the estimation reference image. The estimation module 201 inputs the estimation target feature calculated by each layer to the decoder D, and the decoder D outputs the estimation target segmentation map based on the parameter adjusted through the training. The internal processing of the decoder D may be as described above.

### [3-3. Functions Implemented in User Terminal]

Still referring to FIG. 3, the user terminal 30 includes a data storage unit 300 (or data storage) and a transmission module 301 (or transmitter). The data storage unit 300 is implemented by the storage unit 32. The transmission module 301 is implemented by the control unit 31.

### [Data Storage Unit]

The data storage unit 300 stores data required or used for the generation of the estimation target image. For example, the data storage unit 300 stores the estimation target image generated by the photographing unit 36.

### [Transmission Module]

The transmission module 301 transmits the estimation target image generated by the photographing unit 36 to the server 20. The transmission module 301 may transmit the estimation target image stored in the data storage unit 300 to the server 20.

### [4. Processing Executed in Image Processing System]

Description is now given of training processing of executing the training of the learning model M and estimation processing of using the trained learning model M as an example of processing executed in the image processing system 1.

### [4-1. Training Processing]

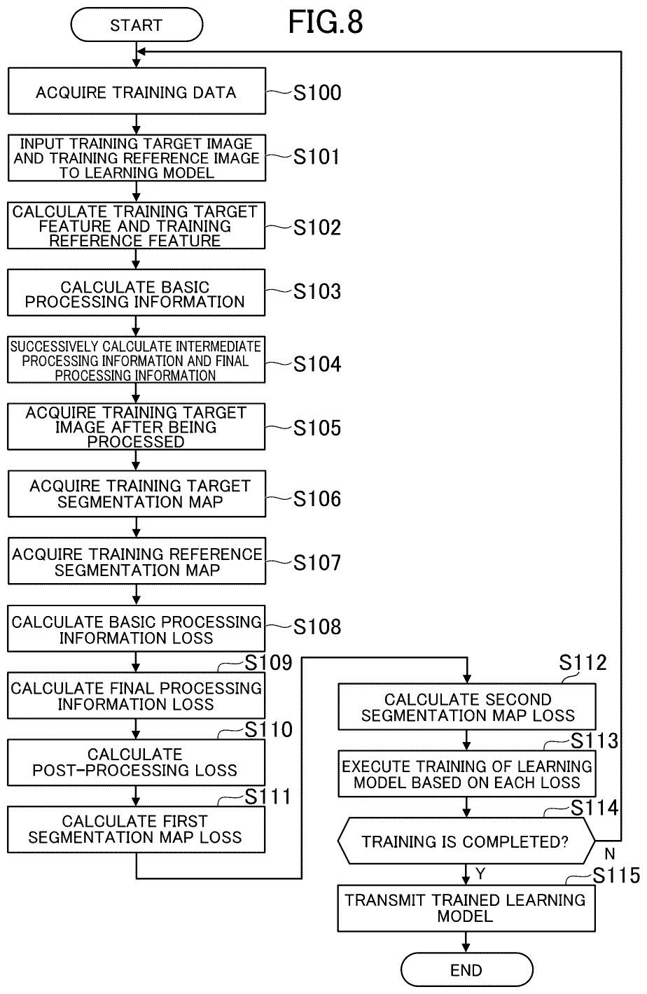

FIG. 8 is a flowchart for illustrating an example of the training processing. The training processing may be executed by the control unit 11 executing the program stored in the storage unit 12.

As illustrated in FIG. 8, the learning terminal 10 acquires the training data from the training database DB (Step S100). The learning terminal 10 inputs the training target image Iₜ and the training reference image Iᵣ being the input portion of the training data to the learning model M (Step S101). The learning terminal 10 calculates the training target feature fₜ^{l} and the training reference feature fᵣ^{l} based on the training target image Iₜ, the training reference image Iᵣ, and the encoder E (Step S102). The learning terminal 10 calculates the basic processing information H based on the training target feature fₜ^{l}, the training reference feature fᵣ^{l}, and the first network N1 (Step S103). The learning terminal 10 successively calculates the pieces of intermediate processing information w^{l-1} to w¹ and the final processing information “w” based on the first network N1, the basic processing information H, and the training target features fₜ^{l} to fₜ¹ and the training reference features fᵣ^{l} to fᵣ¹ calculated by the respective layers of the encoder E (Step S104).

The learning terminal 10 processes the training target image Iₜ based on the final processing information “w”, to thereby acquire the training target image (Iₜ, w) after being processed (Step S105). The learning terminal 10 acquires the training target segmentation map sₜ (hat) based on the decoder D and the processed training target features T(fₜ^{l}, H) to T(fₜ¹, w¹) intermediately calculated in Step S104 (Step S106). The learning terminal 10 acquires the training reference segmentation map sᵣ based on the decoder D and the training reference features fᵣ^{l} to fᵣ¹ of the training reference image Iᵣ (Step S107).

The learning terminal 10 calculates the basic processing information loss L_{H} (Expression 1) based on the basic processing information H calculated in Step S103 and the ground truth basic processing information H (bar) included in the training data (Step S108). The learning terminal 10 calculates the final processing information loss L_{w} (Expression 2) based on the final processing information “w” calculated in Step S104 and the ground truth final processing information “w” (bar) included in the training data (Step S109). The learning terminal 10 calculates the post-processing loss L_{I} (Expression 3) based on the processed training target image (Iₜ, w) acquired in Step S105 and the ground truth post-processing information T(Iₜ, w (bar)) included in the training data (Step S110).

The learning terminal 10 calculates the first segmentation map loss Lₛ₁ (Expression 4) based on the training target segmentation map sₜ (hat) acquired in Step S106 and the first ground truth segmentation map sₜ (bar) included in the training data (Step S111). The learning terminal 10 calculates the second segmentation map loss Lₛ₂ (Expression 5) based on the training reference segmentation map sᵣ acquired in Step S107 and the first ground truth segmentation map sₜ (bar) included in the training data (Step S112).

The learning terminal 10 executes the training of the learning model M based on the losses calculated in Step S118 to Step S112 (Step S113). The learning terminal 10 determines whether or not to complete the training (Step S114). In Step S114, the learning terminal 10 may determine whether or not each loss has fallen below a threshold value, or may determine whether or not the learning model M has learned a predetermined number of pieces of training data. When it is not determined to complete the training (N in Step S114), the learning terminal 10 returns the process to Step S100. When it is determined to complete the training (Y in Step S114), the learning terminal 10 transmits the trained learning model M to the server 20 (Step S115), and this processing is finished. The server 20 records the trained learning model M in the storage unit 22.

### [4-2. Estimation Processing]

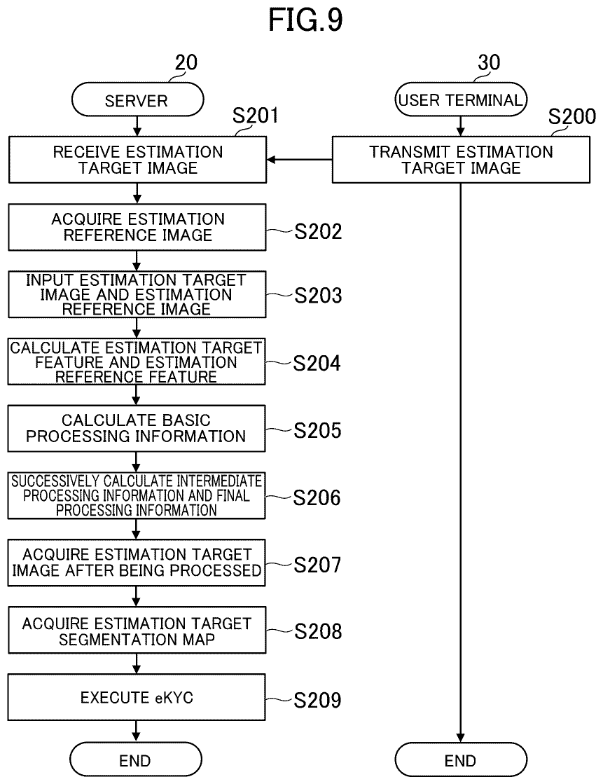

FIG. 9 is a flowchart for illustrating an example of the estimation processing according to an embodiment. The estimation processing may be executed by the control units 21 and 31 executing the programs stored in the storage units 22 and 32, respectively. It is assumed that the training processing has been executed before the estimation processing is executed.

As illustrated in FIG. 9, the user terminal 30 generates the estimation target image based on the capturing result of the photographing unit 36, and transmits the estimation target image to the server 20 (Step S200). The server 20 receives the estimation target image from the user terminal 30 (Step S201). The server 20 acquires the estimation reference image stored in the storage unit 22 (Step S202). It is assumed that the estimation reference document is shown in an appropriate posture in the estimation reference image. The server 20 inputs the estimation target image and the estimation reference image to the trained learning model M (Step S203).

For example, the server 20 calculates, based on the estimation target image, the estimation reference image, and the encoder E, the estimation target feature being a feature of the estimation target image and the estimation reference feature being a feature of the estimation reference image (Step S204). The server 20 calculates the basic processing information based on the estimation target feature, the estimation reference feature, and the first network N1 (Step S205). The server 20 successively calculates the intermediate processing information and the final processing information based on the first network N1, the basic processing information, and the estimation target feature and the estimation reference feature calculated by each layer of the encoder E (Step S206).

The server 20 processes the estimation target image based on the final processing information, to thereby acquire the estimation target image after being processed (Step S207). The server 20 acquires the estimation target segmentation map based on the decoder D and the processed estimation target feature calculated intermediately in Step S206 (Step S208). The server 20 executes the eKYC based on the processed estimation target image acquired in Step S207 and the estimation target segmentation map acquired in Step S208 (Step S209), and this processing is finished.

### [5. Summary of at Least One Embodiment]

The image processing system 1 according to at least one embodiment acquires the training data including, as the input portion, the training target image Iₜ and the training reference image Iᵣ and including, as the ground truth portion, the ground truth information for processing the training target image Iₜ so that the training target posture matches the training reference posture. The image processing system 1 trains, based on the training data, the learning model M for image processing so that the ground truth information is output when the training target image Iₜ and the training reference image Iᵣ are input. As a result, the image processing system 1 can create the learning model M which does not require execution of processing imposing a high load, such as extraction of a feature point group and the like. Hence, according to example embodiments, it is possible to reduce a processing load on a computer (for example, the server 20) which uses the trained learning model M. For example, when the image processing system 1 is applied to the eKYC and even when the identity verification document is blurred or light is reflected thereon, but when sufficient features appear in another portion, the image processing system 1 can cause the learning model M to recognize a feature of the other portion to execute appropriate processing. Thus, the image processing system 1 can achieve highly accurate processing.

Moreover, the learning model M includes the encoder E which calculates the training target features fₜ¹ to fₜ^{l} and the training reference features fᵣ^{l} to fᵣ^{l} and the first network N1 which calculates the processing information based on the training target features fₜ¹ to fₜ^{l} and the training reference features fᵣ¹ to fᵣ^{l}. The image processing system 1 trains the encoder E and the first network N1 of the learning model M. As a result, the image processing system 1 is not required to execute processing having a high load, such as the extraction of the feature point group, in order to acquire the processing information. Hence, it is possible to reduce a processing load on a computer (for example, the server 20) which acquires the processing information. For example, even when the identity verification document is blurred or light is reflected thereon, the image processing system 1 can achieve appropriate processing through use of the encoder E and the first network N1.

Moreover, the encoder E includes a plurality of layers which calculate the training target features fₜ¹ to fₜ^{l} and the training reference features fᵣ¹ to fᵣ^{l}. The first network N1 calculates, for each layer, the processing information based on each of the training target features fₜ¹ to fₜ^{l} and each of the training reference features fᵣ¹ to fᵣ^{l} calculated by this layer, to thereby calculate the final version of the processing information. As a result, the image processing system 1 acquires the final version of the processing information comprehensively reflecting the training target features fₜ¹ to fₜ^{l} and the training reference features fᵣ¹ to fᵣ^{l} calculated by the plurality of layers, thereby being able to create the learning model M which acquires highly accurate processing information.

Moreover, the ground truth information includes the ground truth processing information (for example, the ground truth basic processing information H (bar) and the like). The image processing system 1 calculates the processing information loss (for example, the basic processing information loss L_{H}) based on the processing information (for example, the basic processing information H) calculated by the first network N1 at the time of training and the ground truth processing information, and trains the learning model M based on this processing information loss. As a result, the image processing system 1 can create such a highly accurate learning model M that the ground truth processing information serving as desired processing information can be obtained.

Moreover, the encoder E includes a plurality of layers which calculate the training target features fₜ¹ to fₜ^{l} and the training reference features fᵣ¹ to fᵣ^{l}. The first network N1 calculates the basic processing information H calculated based on the training target features fₜ¹ to fₜ^{l} and the training reference features fᵣ¹ to fᵣ^{l} calculated by the last layer out of the plurality of layers. The ground truth processing information includes the ground truth basic processing information H (bar). The image processing system 1 calculates the basic processing information loss L_{H} based on the basic processing information H calculated at the time of training and the ground truth basic processing information H (bar), and trains the learning model M based on this basic processing information loss L_{H}. As a result, the image processing system 1 can create such a highly accurate learning model M that desired ground truth basic processing information H (bar) can be obtained.

Moreover, the encoder E includes a plurality of layers which calculate the training target features fₜ¹ to fₜ^{l} and the training reference features fᵣ¹ to fᵣ^{l}. The first network N1 calculates, for each layer starting from a layer later in sequence out of the plurality of layers, the pieces of intermediate processing information w^{l-1} to w¹ based on the training target features fₜ¹ to fₜ^{l} and the training reference features fᵣ¹ to fᵣ^{l} calculated by this layer, to thereby calculate final processing information “w” being the final version of the processing information. The ground truth processing information includes the ground truth final processing information “w” (bar). The image processing system 1 calculates a final processing information loss L_{w} based on the final processing information “w” calculated at the time of training and the ground truth final processing information “w” (bar), and trains the learning model M based on this final processing information loss L_{w}. As a result, the image processing system 1 can create such a highly accurate learning model M that desired ground truth final processing information “w” (bar) can be obtained.

Moreover, the ground truth information includes ground truth post-processing information. The image processing system 1 calculates the post-processing loss L_{I} based on the training target image T(Iₜ, w) processed based on the processing information calculated by the first network N1 at the time of training and the ground truth post-processing information T(Iₜ, w (bar)) and trains the learning model M based on this post-processing loss L_{I}. As a result, the image processing system 1 can create a highly accurate learning model M which achieves the processing corresponding to the desired ground truth post-processing information T(Iₜ, W (bar)).

Moreover, the learning model M includes the decoder D which outputs the segmentation map “s” and the other portion which processes the training target image Iₜ. For example, the image processing system 1 calculates the first segmentation map loss Lₛ₁ based on the training target segmentation map sₜ (hat) of the processed training target image T(Iₜ, w) processed through use of the other portion and the first ground truth segmentation map sₜ(bar) serving as the ground truth of this processed training target image T(Iₜ, w), and trains the learning model M based on this first segmentation map loss Lₛ₁. As a result, the image processing system 1 can create such a highly accurate learning model M that not only the image is processed but also a desired segmentation map “s” can be obtained.

Moreover, the decoder D outputs the training target segmentation map sₜ (hat) indicating the posture and the type of the training target document in the training target image Iₜ. The first ground truth segmentation map sₜ (bar) indicates the posture and the type serving as the ground truth. As a result, the image processing system 1 can create such a highly accurate learning model M that a desired posture and a desired type can be estimated.

Moreover, the image processing system 1 calculates the second segmentation map loss Lₛ₂ based on the training reference segmentation map sᵣ of the training reference image Iᵣ and the second ground truth segmentation map sᵣ (bar) serving as the ground truth of the training reference image Iᵣ, and trains the learning model M based on this second segmentation map loss Lₛ₂. As a result, the image processing system 1 can create such a highly accurate learning model M that the second ground truth segmentation map sᵣ (bar) can be obtained.

Moreover, the decoder D outputs the training reference segmentation map sᵣ indicating the posture and the type of the training reference document in the training reference image Iᵣ. The second ground truth segmentation map sᵣ (bar) indicates the posture and the type serving as the ground truth. As a result, the image processing system 1 can create such a highly accurate learning model M that a desired posture and a desired type can be estimated.

Moreover, the image processing system 1 inputs the estimation target image and the estimation reference image to the trained learning model M, and acquires the processed estimation target image processed so that the estimation target posture matches the estimation reference posture. As a result, the image processing system 1 can acquire the processed estimation target image based on the learning model M which does not require execution of processing imposing a high load, such as the extraction of the feature point group and the like, and hence the processing load on the computer (for example, the server 20) which uses the trained learning model M can be reduced. For example, when the image processing system 1 is applied to the eKYC and even when the identity verification document is blurred or light is reflected thereon, but when sufficient features appear in another portion, the image processing system 1 causes the learning model M to recognize the feature of the other portion, thereby being able to execute appropriate processing. Thus, the image processing system 1 can achieve highly accurate processing.

Moreover, the image processing system 1 inputs the estimation target image and the estimation reference image to the learning model M including the trained encoder E and the first network N1 and acquires the processed estimation target image. As a result, the image processing system 1 is not required to execute the processing having a high load, such as the extraction of the feature point group, in order to acquire the processing information, and hence it is possible to reduce the processing load on the computer (for example, the server 20) which acquires the processing information. For example, even when the identity verification document is blurred or light is reflected thereon, the image processing system 1 can achieve appropriate processing through use of the encoder E and the first network N1.

Moreover, the estimation module 201 of the image processing system 1 acquires, based on the decoder D, the estimation target segmentation map being the segmentation map corresponding to the processed estimation target image processed through use of the other portion other than the decoder D. As a result, the image processing system 1 can not only process the image, but can also acquire a desired segmentation map.

### [6. Modification Examples]

The present disclosure is not limited to the embodiments described above, and can be modified suitably without departing from the spirit and scope of the present disclosure.

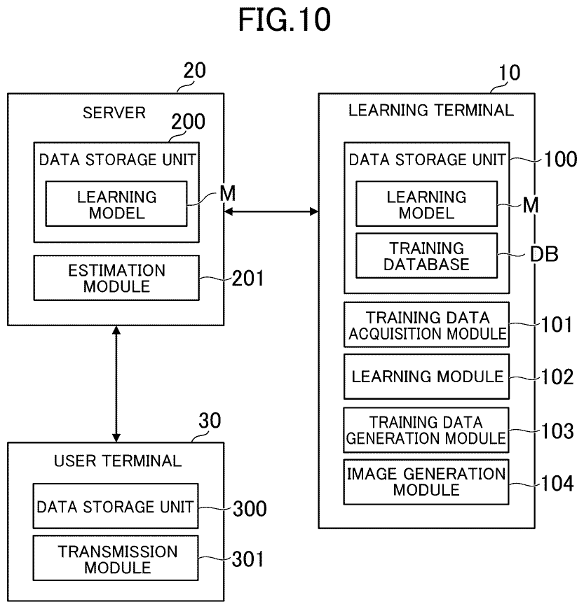

FIG. 10 is a diagram for illustrating an example of functions implemented in modification examples of the present disclosure. The image processing system 1 according to the modification examples includes a training data generation module 103 (or training data generator) and an image generation module 104 (or image generator). Each of the training data generation module 103 and the image generation module 104 may be implemented by the control unit 11.

### [6-1. Modification Example 1]

The identity verification document to be used as the training data may include personal information. A person indicated by the personal information, however, may not want the personal information learned by the learning model M. According to an embodiment, the image processing system 1 does not allow the learning model M to learn the personal information, but causes the learning model M to learn the feature of the training target image Iₜ for appropriate processing. In this caes, the personal information may become noise at the time of training. Thus, in Modification Example 1, description is given of a case in which the training target image Iₜ and the training reference image Iᵣ are processed so that features of the personal information are reduced are acquired.

The image processing system 1 according to Modification Example 1 includes the training data generation module 103. The training data generation module 103 processes the personal information included in an original image being an origin of each of the training target image Iₜ and the training reference image Iᵣ, to thereby generate the training data. It is also assumed that the original image is stored in the data storage unit 100. The original image may show the identity verification document of a person belonging to a certain organization or another document other than the identity verification document.

For example, the training data generation module 103 identifies a portion of the document shown in the original image in which the personal information is included. In Modification Example 1, it is assumed that the personal information is included in a region of the original image that is defined in advance. The training data generation module 103 executes image processing of reducing a feature of the personal information on the region of the original image that is defined in advance, to thereby acquire the training target document and the training reference image Iᵣ.

The image processing to be executed on the personal information is processing for making the personal information less likely to be identified, and may be any image processing. For example, the image processing may be at least one of blurring processing, mosaic processing, mask (filling) processing, cropping processing, processing of applying texture, and other processing. Moreover, the personal information is basically characters. Thus, the training data generation module 103 may execute optical character recognition on the original image to identify a portion of the characters, and may execute the image processing while considering the portion of the characters of the original image as the personal information.

For example, the training data generation module 103 may directly acquire, as the training target image Iₜ, the image obtained by processing (or concealing) the personal information of the original image. The training data generation module 103 may acquire, as the training reference image Iᵣ, an image obtained by applying image processing such as affine transform to the training target image Iₜ, to thereby change the posture of the training target document. The training data generation module 103 acquires, as the input portion of the training data, the acquired training target image Iₜ and training reference image Iᵣ. The ground truth portion of the training data may be specified by the creator of the learning model M.

For example, the training data generation module 103 may directly acquire, as the training reference image Iᵣ, an image obtained by processing (or concealing) the personal information of the original image. The training data generation module 103 may acquire, as the training target image Iₜ, an image obtained by applying image processing such as affine transform to the training reference image Iᵣ, to thereby change the posture of the training reference document. The training data generation module 103 acquires, as the input portion of the training data, the acquired training target image Iₜ and training reference image Iᵣ. The ground truth portion of the training data may be specified by the creator of the learning model M.

The image processing system 1 according to Modification Example 1 processes the personal information included in the original image being the origin of each of the training target image Iₜ and the training reference image Iᵣ, to thereby generate the training data. As a result, the image processing system 1 can prevent the use of the personal information in an inappropriate form for the person indicated by the personal information. The image processing system 1 can also cause the learning model M to learn not the personal information, but the features for appropriate processing.

### [6-2. Modification Example 2]

According to an embodiment, the learning model M may consider not only the posture of each of the training target document and the training reference document, but also backgrounds thereof, to thereby make the estimation for the processing. In the estimation target image captured by the user, various backgrounds are sometimes included. Thus, in Modification Example 2, description is given of a case in which such a training target document and a training reference document that the learning model M can learn the various backgrounds are generated.

The image processing system 1 according to Modification Example 2 includes the image generation module 104. The image generation module 104 generates the training target image Iₜ and the training reference image Iᵣ based on an original document image showing an original document being an origin of each of the training target document and the training reference document and a background image prepared in advance and showing the background. It is assumed that the original document image and the background image are stored in the data storage unit 100. The data storage unit 100 stores the original document images each showing the document in one of the plurality of postures and the background images each showing one of the plurality of backgrounds.

For example, the original document image is an image in which an original document being a document of the same type as that of at least one of the training target document or the training reference document is shown. The original document image may be prepared by the person who creates the learning model M, or may be prepared by another person. In the original document image, the original document may be shown in any posture. For example, in the original document image, the original document in the same posture as the posture of the training target document, the original document in the same posture as the posture of the training reference document, or the original document in another posture may be shown. The image generation module 104 may execute image processing such that the posture of the original document shown in the original document image changes, to thereby generate at least one of the training target image Iₜ or the training reference image Iᵣ. The image generation module 104 may execute such image processing that the posture becomes a posture defined in advance, or may execute such image processing that the posture becomes a random posture.

For example, in the background images, backgrounds different in color, design, brightness, pattern, object, or a combination thereof are shown. The background image may also be referred to as a “texture image.” The image generation module 104 selects any one of the plurality of background images, and superimposes the original document shown in the original document image for the training target image Iₜ on the background shown in this background image, to thereby compose the original document image and the background image with each other to generate the training target image Iₜ. The image generation module 104 selects any one of the plurality of background images, and superimposes the original document shown in the original document image for the training reference image Iᵣ on the background shown in this background image, to thereby compose the original document image and the background image with each other to generate the training reference image Iᵣ. The training data is generated based on the training target image Iₜ and the training reference image Iᵣ generated by the image generation module 104.

The image processing system 1 according to Modification Example 2 generates the training target image Iₜ and the training reference image Iᵣ based on the original document image in which the original document being the origin of each of the training target document and the training reference document is shown and the background image prepared in advance and showing the background. As a result, the image processing system 1 can cause the learning model M to learn the features of various backgrounds, and hence the image processing system 1 can increase the accuracy of the learning model M. The image processing system 1 can reduce a time taken to prepare the training data, and hence the image processing system 1 can also increase convenience for the creator of the learning model M.

### [6-3. Other Modification Examples]

In one or more other embodiments, the above-mentioned modification examples may be combined with one another.

For example, the functions described as those implemented in the learning terminal 10 may be implemented in another computer such as the server 20. The functions described as those implemented in the learning terminal 10 may be distributed to the learning terminal 10 and another computer. The functions described as those implemented in the server 20 may be implemented in another computer such as the user terminal 30. The functions described as those implemented in the server 20 may be distributed to the server 20 and another computer.

While there have been described what are at present considered to be certain embodiments of the invention(s), it will be understood that various modifications may be made thereto, and it is intended that the appended claims cover all such modifications as falling within the true spirit and scope of the invention(s).

What is claimed is:

1. An image processing system, comprising at least one processor configured to:
acquire training data including, as an input portion, a training target image in which a training target document is shown and a training reference image in which a training reference document is shown and including, as a ground truth portion, ground truth information for processing the training target image so that a training target posture of the training target document in the training target image matches a training reference posture of the training reference document in the training reference image; and
train, based on the training data, a learning model for image processing so that the ground truth information is output when the training target image and the training reference image are input.

2. The image processing system according to claim 1,
wherein the learning model includes:
an encoder configured to calculate a training target feature of the training target image and a training reference feature of the training reference image; and
a first network configured to calculate processing information relating to the processing of the training target image based on the training target feature and the training reference feature, and
wherein the at least one processor is configured to train the encoder and the first network of the learning model.

3. The image processing system according to claim 2,
wherein the encoder includes a plurality of layers configured to calculate the training target feature and the training reference feature, and
wherein the first network is configured to calculate the processing information for each of the plurality of layers based on the training target feature and the training reference feature calculated by the each of the plurality of layers, to thereby calculate a final version of the processing information.

4. The image processing system according to claim 2,
wherein the ground truth information includes ground truth processing information being processing information serving as ground truth, and
wherein the at least one processor is configured to calculate a processing information loss based on the processing information calculated by the first network at a time of training and the ground truth processing information, and train the learning model based on the processing information loss.

5. The image processing system according to claim 4,
wherein the encoder includes a plurality of layers configured to calculate the training target feature and the training reference feature,
wherein the first network is configured to calculate basic processing information being the processing information calculated based on the training target feature and the training reference feature calculated by a last layer out of the plurality of layers,
wherein the ground truth processing information includes ground truth basic processing information being basic processing information serving as ground truth, and
wherein the at least one processor is configured to calculate a basic processing information loss based on the basic processing information calculated at the time of training and the ground truth basic processing information, and train the learning model based on the basic processing information loss.

6. The image processing system according to claim 4,
wherein the encoder includes a plurality of layers configured to calculate the training target feature and the training reference feature,
wherein the first network is configured to calculate, for each of the plurality of layers starting from a layer later in sequence out of the plurality of layers, intermediate processing information being an intermediate version of the processing information based on the training target feature and the training reference feature calculated by the each of the plurality of layers, to thereby calculate final processing information being a final version of the processing information,
wherein the ground truth processing information includes ground truth final processing information being final processing information serving as ground truth, and
wherein the at least one processor is configured to calculate a final processing information loss based on the final processing information calculated at the time of training and the ground truth final processing information, and train the learning model based on the final processing information loss.

7. The image processing system according to claim 2,
wherein the ground truth information includes ground truth post-processing information relating to the training target image after being processed serving as ground truth, and
wherein the at least one processor is configured to calculate a post-processing loss based on the ground truth post-processing information and the training target image processed based on the processing information calculated by the first network at the time of training, and train the learning model based on the post-processing loss.

8. The image processing system according to claim 1,
wherein the learning model includes a decoder configured to output a segmentation map and another portion configured to process the training target image, and
wherein the at least one processor is configured to calculate a first segmentation map loss based on a training target segmentation map being the segmentation map of a processed training target image being the training target image processed through use of the other portion and a first ground truth segmentation map serving as ground truth of the processed training target image, and train the learning model based on the first segmentation map loss.

9. The image processing system according to claim 8,
wherein the decoder is configured to output the training target segmentation map indicating the training target posture and a type of the training target document in the training target image, and
wherein the first ground truth segmentation map indicates the training target posture and the type serving as ground truth.

10. The image processing system according to claim 1,
wherein the learning model includes a decoder configured to output a segmentation map and another portion configured to process the training target image, and
wherein the at least one processor is configured to calculate a second segmentation map loss based on a training reference segmentation map being the segmentation map of the training reference image and a second ground truth segmentation map serving as ground truth of the training reference image, and train the learning model based on the second segmentation map loss.

11. The image processing system according to claim 10,
wherein the decoder is configured to output the training reference segmentation map indicating the training reference posture and a type of the training reference document in the training reference image, and
wherein the second ground truth segmentation map indicates the training reference posture and the type serving as ground truth.

12. The image processing system according to claim 1, wherein the at least one processor is configured to generate the training data by processing personal information included in an original image being an origin of each of the training target image and the training reference image.

13. The image processing system according to claim 1, wherein the at least one processor is configured to generate the training target image and the training reference image based on an original document image showing an original document being an origin of each of the training target document and the training reference document and a background image prepared in advance and showing a background.

14. The image processing system according to claim 1, wherein the at least one processor is configured to input, to the trained learning model, an estimation target image in which an estimation target document is shown and an estimation reference image in which an estimation reference document is shown, and acquire a processed estimation target image being the estimation target image processed so that an estimation target posture of the estimation target document matches an estimation reference posture of the estimation reference document.

15. The image processing system according to claim 14,
wherein the learning model includes:
an encoder configured to calculate a training target feature of the training target image and a training reference feature of the training reference image; and
a first network configured to calculate processing information relating to the processing of the training target image based on the training target feature and the training reference feature, and
wherein the at least one processor is configured to:
train the encoder and the first network of the learning model; and
input the estimation target image and the estimation reference image to the learning model including the trained encoder and the trained first network and acquire the processed estimation target image.

16. The image processing system according to claim 14,
wherein the learning model includes a decoder configured to output a segmentation map and another portion configured to process the training target image, and
wherein the at least one processor is configured to:
calculate a first segmentation map loss based on a training target segmentation map being the segmentation map of the training target image processed through use of the other portion and a first ground truth segmentation map serving as ground truth of the processed training target image, and train the learning model based on the first segmentation map loss; and
acquire, based on the decoder, an estimation target segmentation map being the segmentation map corresponding to the processed estimation target image processed through use of the other portion.

17. An image processing method, comprising:
acquiring training data including, as an input portion, a training target image in which a training target document is shown and a training reference image in which a training reference document is shown and including, as a ground truth portion, ground truth information for processing the training target image so that a training target posture of the training target document in the training target image matches a training reference posture of the training reference document in the training reference image; and
training, based on the training data, a learning model for image processing so that the ground truth information is output when the training target image and the training reference image are input.

18. A non-transitory information storage medium having stored thereon a program for causing a computer to:
acquire training data including, as an input portion, a training target image in which a training target document is shown and a training reference image in which a training reference document is shown and including, as a ground truth portion, ground truth information for processing the training target image so that a training target posture of the training target document in the training target image matches a training reference posture of the training reference document in the training reference image; and
train, based on the training data, a learning model for image processing so that the ground truth information is output when the training target image and the training reference image are input.
